(19) United States
(12) Patent Application Publication
(10) Pub. No.: US 2014/0283465 A1
(43) Pub. Date: Sep. 25, 2014

(54) BUILDING SYSTEM

(71) Applicant: DAVID AJASA-ADEKUNLE, London (GB)

(72) Inventor: David Ajasa-Adekunle, London (GB)

(21) Appl. No.: 14/239,078

(22) PCT Filed: Aug. 14, 2012
(86) PCT No.: PCT/GB2012/000658

§ 371 Date: Feb. 14, 2014

(30) Foreign Application Priority Data
Aug. 14, 2011 (GB) 1113947.4

(51) Int. Cl. E04H 1/04; E04B 1/343; H02G 3/22; E04H 1/00; E04B 1/348

(52) U.S. Cl. CPC E04H 1/04; E04H 1/005; E04B 1/348; H02G 3/22; E04B 1/34384
USPC 52/79.9; 52/578; 52/236.3; 52/220.1

(57) ABSTRACT

A building system comprises building module 16 24 in the shape of a truncated tetrahedron wherefrom a building can be constructed on a horizontal surface 18 by making horizontal tessellations of a first form 16 of module where the module 16 sits on a hexagonal faces and a second form 24 of module where the module 24 sits upon a triangular face, tessellation being achieved when a hexagonal panel 20 of a first form 16 of module is abutted against a hexagonal panel 20 of a second form of module. Multi-storey buildings can be constructed using the upper surfaces created from contiguaus topmost panels 26 28 being employed as the horizontal surface 18 26 28 for construction of an upper storey tessellation. Alignment of upper 26 28 and tower like panels between the upper surfaces of one storey and the tower surfaces of the next higher storey permits automatic creation of utility ducts 30 within the multi storey building. Use of single building modules is also shown in the form of a workshop or outdoor office and in the form of a summerhouse that can have a sectional hexagonal door in the form of six hinged triangular sections that meet, when closed, at the hexagon centre and can be opened by a winch mechanism.

The present invention relates to a building system incorporating a building module suitable for use as a single unit, and also suitable for use as part of a larger system built structure.

A building module is here before and here after defined as an assembled building structure capable of providing occupancy, entrance and exit for one or more creatures including, but not limited to, human beings.

It is known to construct “system” buildings from a standardized set of pre-constructed parts. The parts can comprise pre-fabricated construction panels forming walls, floors and ceilings that are assembled to provide a single or multi-storey building as a series of building modules which fit together. The parts can also be assembled to provide a single building module. In the known art, the pre-fabricated panels are generally square of rectangular in shape and the structures they are assembled to form are generally cuboids in shape which are not non structurally self-rigid no matter how strong the individual panels might be and rely upon gravity to maintain structural integrity, much as assembled bricks in brickwork require gravity and verticality to maintain their formal integrity. The present invention seeks to provide improvement over the prior art by providing for a building module of improved self-rigidity and strength. The present invention also seeks to provide improvement over the prior art by allowing the possibility of using individual panels that can be of lesser individual strength than previously required.

It is also known to that system buildings are constructed to be permanent. The individual pre-constructed parts are heavy, breakable and frangible. When a system building is to be removed, full destructive demolition is required. The present invention seeks to improve over this situation by providing a building module capable of integration into a system building that can be later disassembled and individual building modules used again in other structures.

United States Patent Application US-2010-0236184-A1 shows how and internal structural support frames with four apices provided in the form of a tetrahedron provide surprisingly high strength to structures which they support. The present invention seeks improvement there over by providing a building module the strength of a tetrahedral structure without a requirement for an internal tetrahedral support structure.

United States Patent Application US-2010-0252518-A shows how an external, tetrahedral support frame can also impart great strength. The present invention seeks to provide improvement there over by eliminating the need for an external support frame in a building module at the same time imparting tetrahedral strength. These prior art documents all relate to strength imparted by tetrahedral frame structures. The present invention seeks to provide improvement there over by using, instead, tetrahedral shells to impart strength.

These prior art documents discuss only straightforward tetrahedrons. The present invention seeks to provide improvement there over by showing how a modification to the tetrahedron structure can allow advantageous combination of modified tetrahedrons.

According to a first aspect, the present invention consists in a modular building system for assembling a building on a horizontal surface; the system comprising: at least two building modules: where each the at least two building modules is of identical size; and each of the at least two building modules is in the shape of a truncated tetrahedron; where, to assemble a building: one or more of a first form of building module is assembled with a hexagonal face against the horizontal surface; one or more of a second form of building module is assembled with a triangular face against the horizontal surface, and a hexagonal surface of a at least one of the first form of building module is assembled exactly to abut with a hexagonal surface of at least one of a second form of building module to provide a horizontally tessellated structure.

The first aspect of the invention also provides a system where, when the system is employed for assembling at least six building modules into a tessellation where one or more triangular depressions are left in the surface of the tessellation, the system can also comprise one or more triangular sections fitted into the one or more depressions to provide a continuous level surface.

The first aspect of the invention also provides a system wherein; the building can comprise a plurality of storeys; and the tessellation of each lower storey can provide an upper horizontal surface for construction of the next uppermost storey.

The first aspect of the invention also provides a system wherein, if a lower storey presents one or more hexagonal uppermost faces of one or more building modules, the one or more hexagonal uppermost faces can abut hexagonal lowermost faces of one or more building modules in an upper storey, and if a lower storey presents one or more triangular uppermost faces of one or more building modules, the one or more triangular uppermost faces can abut triangular lowermost faces in an upper storey.

The first aspect of the invention also provides a system wherein abutment of respective uppermost and lowermost hexagonal faces and alignment of respective uppermost and lowermost triangular faces can provide one or more through passages for provision of services and utilities, and that the services and utilities can comprise at least one of: water supply pipes; sewerage pipes; gas pipes; electrical cables; ventilation ducts and pathways; data cables; and roof drainage.

The first aspect of the invention also provides a system wherein each building module can be provided as inhabitable space of sufficient size to accommodate human beings and their accoutrements.

The first aspect of the invention also provides a system wherein at least one building module can comprise a plurality of constituent panels provided as a plurality of parts for the building module to be assembled on site.

The first aspect of the invention also provides a system wherein at least one building module can be provided completely or party pre-assembled.

The first aspect of the invention also provides a system wherein each panel can comprise at least one of: at least one rigid planar sheet; and where there are provided two or more spaced rigid planar sheets, held there between, at least one of; a damp proof layer; a water proof layer; and a sound proof layer.

The first aspect of the invention also provides a system wherein at least one panel can comprise: edge sealing components; where the edge sealing components can include panel sealing adapted to seal for the edges of the plurality of spaced rigid planar sheets to isolated the interior from the environment; and environmentally sealed and angularly adapted edges for connection between panels.

According to a second aspect, the present invention consists in a single building module in the form of a truncated tetrahedron, supported by a horizontal surface on a hexagonal face, the building module being of suitable size to accommodate a plurality of human beings, the building module being characterized by comprising: a closable door; and one or more openable and closable window flaps to provide or exclude light from the interior.

The second aspect of the invention further provides that the single building module can comprise a plurality of panels; and that each panel can comprise at least one of:

at least one rigid planar sheet; and where there are provided two or more spaced rigid planar sheets, can comprise held there between, at least one of; a damp proof layer; a water proof layer; and a sound proof layer.

The second aspect of the invention also provides that the least one panel can comprise: edge sealing components; where the edge sealing components can include panel sealing adapted to seal for the edges of the plurality of spaced rigid planar sheets to isolated the interior from the environment; and can also include environmentally sealed and angularly adapted edges for providing connection between panels.

The second aspect of the invention also provides that the single building module can comprise, fitted around a plurality of interior sides thereof, at least one of: at least one continuous horizontal desk fitment; and at least one continuous horizontal shelf fitment.

According to a third aspect, the present invention consists in a single building module in the form of a truncated tetrahedron, supported by a horizontal surface on a triangular face, the building module being of suitable size to accommodate a plurality of human beings, the building module being characterized by comprising: a continuous horizontal bench, fitted around the interior of a plurality of sides thereof.

The third aspect of the invention also provides a single building module which can comprise; a sectional door; where at least a portion of the continuous horizontal bench can be provided on at least a portion of the sectional door to be positioned as extended seating on the exterior of the building module when the sectional door is opened.

The third aspect of the invention also provides a single building module wherein, the sectional door can be in the form of a hexagon covering an hexagonal surface of the building module; the sectional door can comprise six triangular panels each hinged along the hexagon edge; and the triangular panels can be moveable from a closed position where all of the triangular panels meet at the hexagon centre to an open position.

The third aspect of the invention also provides a single building module that can comprise a winch mechanism operable to open and close the triangular panels in common.

The invention is further explained, by way of example, by the following description to be read in conjunction with the appended drawings, in which:

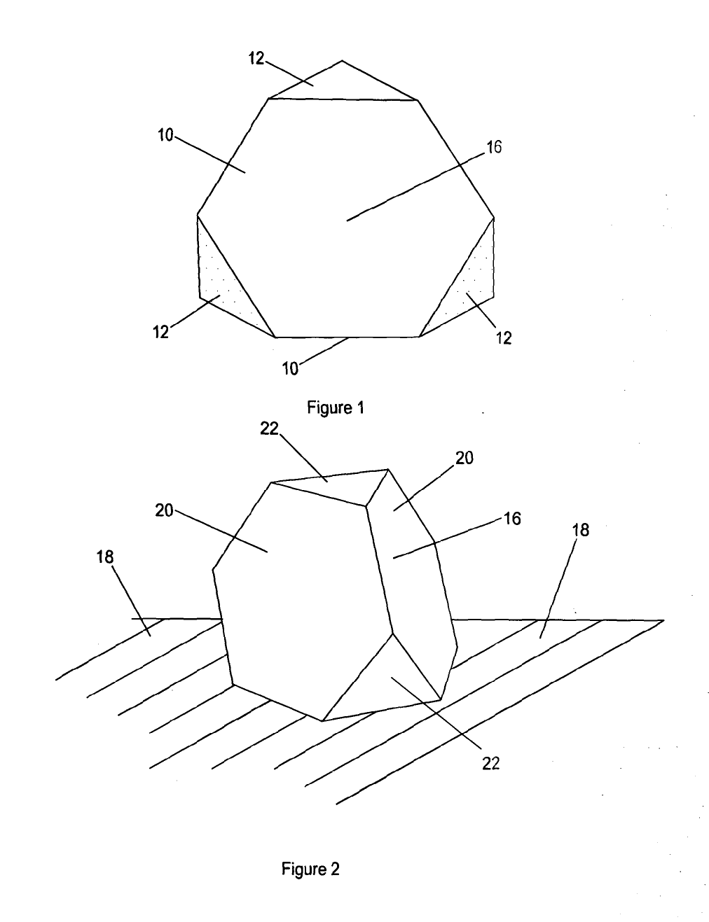

FIG. 1 is a side view of a three-dimensional truncated tetrahedron.

FIG. 2 is a projected view of a first form of building module placed upon a horizontal surface.

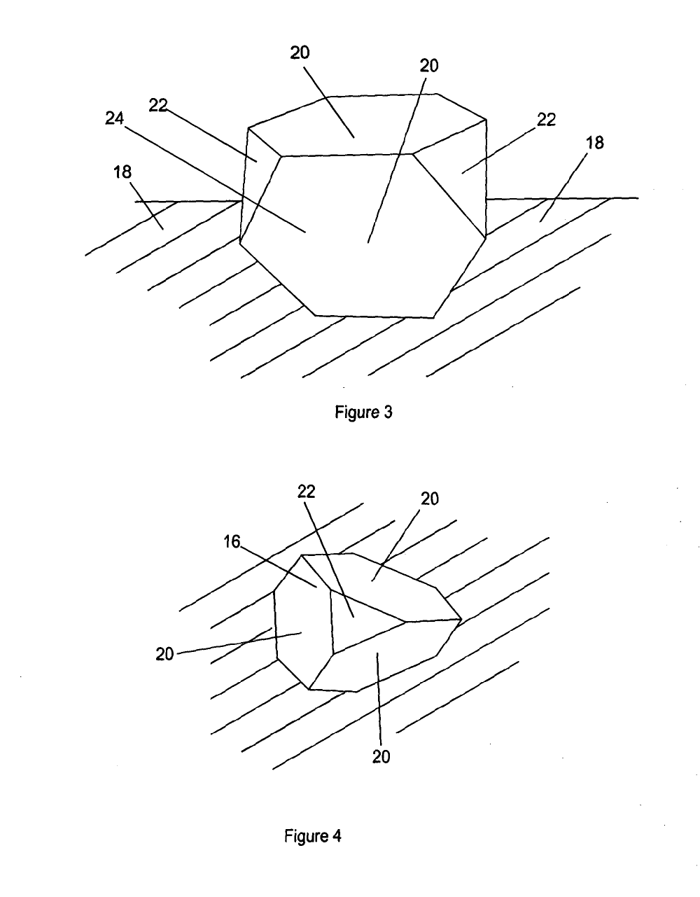

FIG. 3 is a projected view of a second form of building module placed upon the horizontal surface.

FIG. 4 is a view, looking downward, of a first form of building module sitting on the horizontal surface, and represents a first step in a horizontal tessellation of alternate building first and second forms of building module.

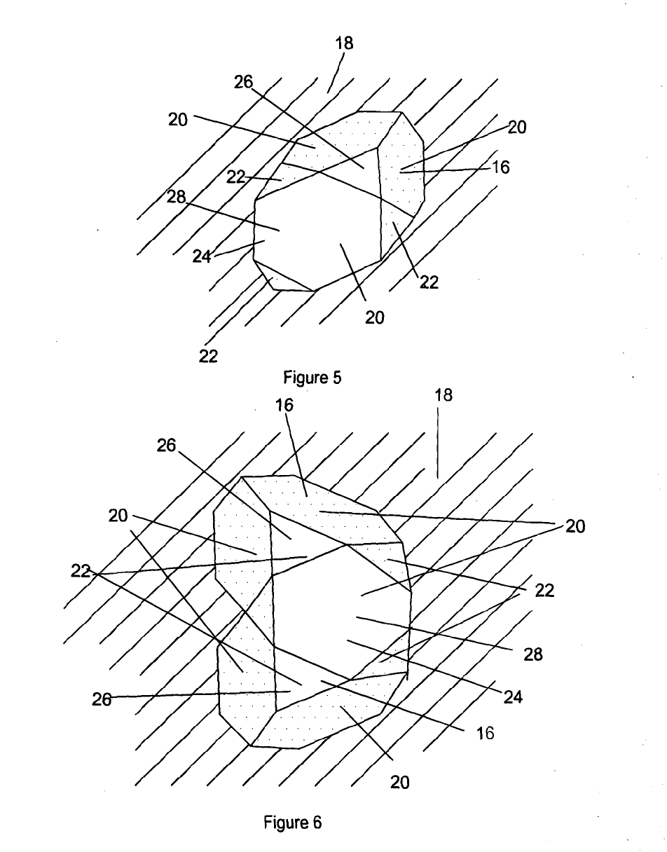

FIG. 5 is a view, looking downward, of a first form of building module tessellated with a second form of building module sitting on the horizontal surface, and represents a second step in a horizontal tessellation of alternate first and second forms of building module.

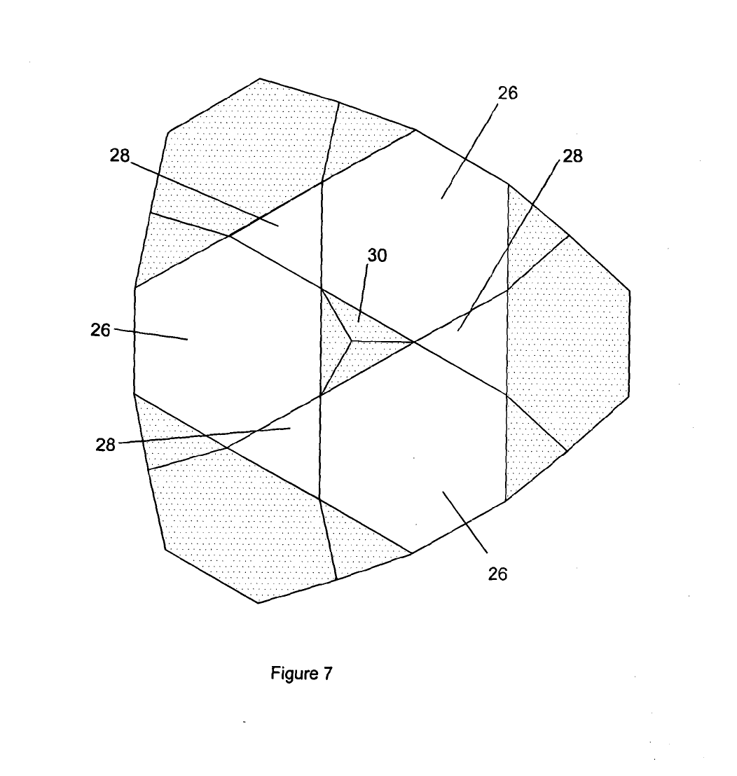

FIG. 6 shows an example of how a further first form of building module can be tessellated against the second form of building module to provide a continuous level surface comprising one topmost triangular panel and two topmost triangular panels.

FIG. 7 shows an example of how six building modules can be assembled into a tessellation to provide a level surface comprising three topmost triangular panels and three topmost hexagonal panels with a depression, in this example, at the tessellation's centre, formed by sloping surfaces.

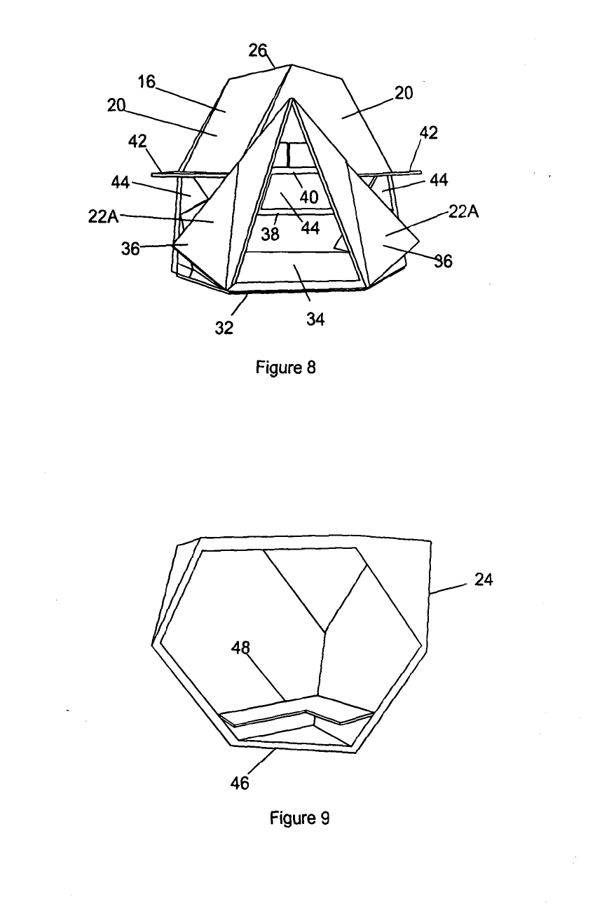

FIG. 8 is a view illustrating one of many possible ways in which a single first form of building module can be utilized.

FIG. 9 is an exemplary view of one of many ways in which a single second form of building module can be used.

and

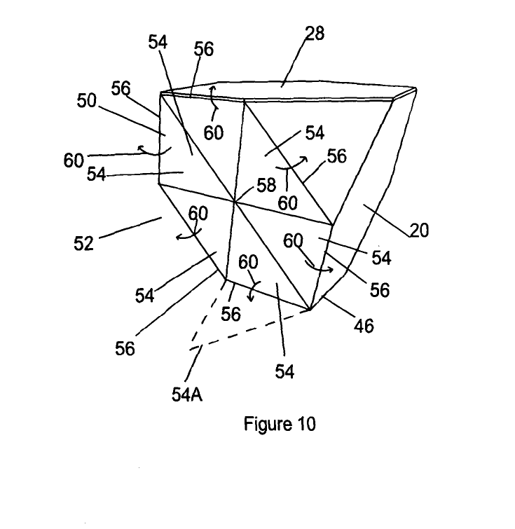

FIG. 10 is another view of the structured of FIG. 9 this time showing one possible manner in which a door may be added.

Attention is first drawn to FIG. 1, a side view of a three-dimensional truncated tetrahedron.

A tetrahedron is a three dimensional solid having four surfaces each in the form of a major equilateral triangle, each of the equilateral triangles being identical with the other three major equilateral triangles.

Truncation of the tetrahedron is achieved by slicing each of the four apices parallel to the opposite equilateral triangular face to leave four identical regular hexagonal faces 10, and to leave four identical triangular faces 12, the faces 12 14 forming the surface of a symmetrical solid body 14.

Attention is next drawn to FIG. 2, a projected view of a first form 16 of building module placed upon a horizontal surface 18. The first form of building module 16 is conformal with the symmetrical solid body 14 of FIG. 1, and is in the form of a truncate tetrahedral shell, hollow in its interior, having four regular hexagonal panels 20 and four regular triangular panels 22. One of the hexagonal panels 20 forms the base of the first form of building module 16.

Attention is next drawn to FIG. 3, a projected view of a second form 24 of building module placed upon the horizontal surface 18. The second form of building module 24 is also conformal with the symmetrical solid body 14 of FIG. 1, and is in the form of a truncate tetrahedral shell, hollow in its interior, having four regular hexagonal panels 20 and four regular triangular panels 22. One of the triangular panels 22 forms the base of the second form of building module 24.

The building modules 16 24 of FIGS. 2 and 3 are both intended for use as inhabitable space, and are accordingly of sufficient size to accommodate human beings and their accoutrements. The first 16 and second 24 forms of building modules 16 24 each have a minimum dimension of around 2.5 metres minimum in height and a maximum height dependent upon the minimum floor area required. The strength and thickness of the module 16 20 walls is made appropriate to the modules' dimensions.

FIG. 3 is a first stage in a horizontal tessellation process which exploits the unexpected property that truncated tetrahedron-shaped building modules 16 24 can be assembled together in a tessellation to provide a habitable space which, as will be seen, can be one or more storeys high.

Attention is next drawn to FIG. 4, a view, looking downward, of a first form 16 of building module sitting on the horizontal surface 18, and representing a first step in a horizontal tessellation of alternate building first 16 and second 24 forms of building module. FIG. 4 also clarifies the dispositions of the triangulated panels 24 and of the hexagonal panels 20. Of particular note is the topmost triangular panel 26 which lies in a horizontal plane parallel to the horizontal surface 18.

Attention is next drawn to FIG. 5, a view, looking downward, of a first form 16 of building module tessellated with a second form 24 of building module sitting on the horizontal surface 18, and representing a second step in a horizontal tessellation of alternate first 16 and second 24 forms of building module. The building module of second form 24 is of identical size with the building module of first form 16. The building module of the second form 24 is set down beside and abuts against the building module of the first form 16 with regular one hexagonal panel 20 on the first form 16 of building module in exact abutment with one hexagonal panel 20 on the second form 24 of building module.

A topmost hexagonal panel 28 lies at the highest point of the second form 24 of building module parallel to the horizontal surface 18 and forms a continuous surface with the topmost triangular panel 26 on the abutted first form 16 of building module.

In FIGS. 4 onwards, all sloping surfaces are shown with dotted shading to differentiate them from level surfaces, which are shown un-shaded.

The order of assembly is not important. While a first form 16 of building module has been shown as being deposed before a second form 24 of building module, within the invention the order can be reversed. What matters is that, in the tessellation involves first forms 16 of building module abutting second forms 24 of building modules.

Attention is next drawn to FIG. 6, showing how a further first form 16 of building module can be tessellated against the second form 24 of building module to provide a continuous level surface comprising one topmost triangular panel 28 and two topmost triangular panels 26.

Attention is next drawn to FIG. 7, showing how six building modules 16 24 can be assembled into a tessellation to provide a level surface comprising three topmost triangular panels 26 and three topmost hexagonal panels 28 with a depression 30, in this example at the tessellation's centre, formed by sloping surfaces.

The examples of tessellations of FIGS. 5 to 7 show only a very small range of what is possible. Tessellated forms need not be entirely filled in, and open spaces can be provided. Tessellations can also be laid out along one or more conjoined strips and may be as large or as small as is required.

Flat conjoined topmost surfaces 26 28 made by topmost triangular panels 16 and topmost hexagonal panels 24 are copied on the lower side by equivalent surfaces that lie against the horizontal surface 18. The lower surface of each tessellation has equivalent indents corresponding to depressions 30. For this reason, the invention makes it possible to provide that the upper surface of a first, ground floor tessellation of building modules 16 24 can form the “horizontal surface” for construction of a stacked second storey first floor tessellation, the upper surface of the second storey tessellation of building modules 16 24 can be used as a “horizontal surface” to make a stacked third storey tessellation, and so on until a stacked structure having a required number of storeys is achieved, having a plurality of building modules in the form of alternate, abutting hexagon-down and triangle-down truncated tetrahedral shells.

Alternate storeys of a stacked structure can be inverted so that, in a vertical direction, topmost regular hexagonal panels 28 abut hexagonal panels 20 in the storey immediately above and topmost regular triangular panel 26 abut triangular panels 22 in the storey immediately above. This has the technical advantage that the depressions 30 are aligned between storeys to provide possible easy to use route for utilities and services, the services and utilities including, but not being limited to, one, some or all of: water supply pipes; sewerage pipes; gas pipes; electrical cables; ventilation ducts and pathways; data cables and roof drainage.

The walls of each module 16 24 can be maintained, or cut away in whole or in part, before or after construction, to allow human occupancy where each module 16 24 is at least one room. Doorways and inter-module 16 24 connecting routes are all in the invention, as well as corridor arrangements. In multi-storey constructions, lift shafts and stairways can also be included within the invention.

In a multi-storey structure, the rigid module 16 24 walls of lower storeys in the stack can made stronger than the walls in higher storeys to accommodate the additional weight of the higher storeys.

The walls of each module 16 24 can be constructed to include, but not to be limited to, a panels having two or more spaced rigid planar sheets which can include, held there between, damp proof, water proof and sound proof layers. The panels can be provided as a plurality of parts for the building module 16 24 to be assembled on site, or can come completely or party assembled. The individual panels can be provided with edge sealing components, incorporating sealing for the edges of the plurality of spaced rigid planar sheets, as well as providing environmentally sealed and angularly adapted edges for each panel.

Depressions 30, especially on topmost surfaces, can, if desired, be covered using a triangular panel 22 to present a continuous flat horizontal surface, with the option of the panel being transparent to admit light.

Attention is next drawn to FIG. 8, a view illustrating one of many possible ways in which a single first form 16 building module can be utilized.

In the example of FIG. 8, a first form 16 of building module is provided external to a mail building to provide an outbuilding such as a garden office, workshop of storage shed.

The first form 16 of building module stands upon a lowest hexagonal face 32 placed upon hard or at least firm standing. The overall height of the first form 16 of building module, in this example, is chosen to be in the range 3.0 metres to 4.0 metres to accommodate human beings, furniture and benches standing on an interior floor 34. A two-part door 36 is hinged to open and carries, as a portion of its structure, part triangular faces 22A which, when the door is closed, come together to form a regular triangular panel 22. A continuous horizontal internal desk or bench 38 is fitted around the inside of the first form 16 of building module on all except the door 36 to provide usable resource for human users and also to provide additional strength and rigidity to the structure. An interior fitted storage shelf 40 can also be provided, again to provide usable resource for human users and also to provide additional strength and rigidity to the structure.

Window flaps 42 (including one which is invisible on the far side of the first form 16 of building module), here shown in the open position, which are completely sealed when they are closed, can be opened and swung aside (in this example, upward) to reveal window openings 44. The window openings 44 can be glazed to provide climate exclusion. Glazed window openings 44 can also be selectably opened or closed.

In this example, the first form 16 of building module is constructed from planar panels comprising two or more spaced rigid planar sheets which can include, held there between, damp proof, water proof and sound proof layers. The panels can be provided as a plurality of parts for the building module 16 24 to be assembled on site, or can come completely or party assembled. The individual panels can be provided with edging sealing components, incorporating sealing for the edges of the plurality of spaced rigid planar sheets, as well as providing environmentally sealed and angularly adapted edges for each panel.

Doors 36 and window openings 44 can be disposed otherwise than shown and described for FIG. 8.

Attention is next drawn to FIG. 9, an exemplary view of one of many ways in which a single second form 24 of building module can be used.

In this example, the second form 24 of building module is provided in the form of a summerhouse or shelter to be provided in a park or garden.

The second form 24 of building module rests upon a lowest triangular surface 46 which is supported from below by solid or at least sufficiently firm standing. The example shown in FIG. 9 provides a considerable technical advantage in requiring only a very small footprint for a structure of its size.

The overall height of the second form 24 of budding module, in this example, is also chosen to be in the range 3.0 metres to 4.0 metres to accommodate human beings.

The upper surface of the second form 24 of building module is a topmost regular hexagonal panel 28 providing maximum area for rain or sun shelter while ground support is provided by the small area of the lowest triangular face 46.

A built in bench 48 allows for seating. One or more book, item or ornament shelves can also be built in. All of these built in items provide improved strength. The construction of the second form 24 of building module can also be the same as for the first form 16 of building module as described with reference to FIG. 8.

While other doors and windows are not strictly necessary for the application described with reference to FIG. 9, they can be provided if desired. Additional benches can be provided, secreted beneath the benches 48 and selectably hinging out from the benches 48 when required. Alternatively, where doors and other openable features are provided, the additional benches can be provided attached on the inner surface thereof and brought forth when the openable features are opened.

Attention is next drawn to FIG. 10, another view of the structure of FIG. 9 showing one way in which a summerhouse door may be added.

The structure of FIG. 9 is provided with a sectional summerhouse door 50 (here shown closed) provided on a modified regular hexagonal face 52 which is split into six hinged triangular sections 54, each hinged triangular section being hinged on their respective edges 56 of the modified hexagonal face 52 away from the hexagon centre 58 as indicated by arrows 60, with an open hinged section 54A shown in broken line, it being understood that all of the hinged sections 54 open in a similar manner.

The individual hinged triangular section may be opened individually, and supported on sprung struts, or preferably, can be opened in common with a winch.

Those, skilled in the art, will be aware of modifications and variations which may be included in the above examples without departing from the invention as claimed.

The invention is more clearly defined by the following appended claims

1. A modular building system for assembling a building on a horizontal surface; the system comprising:
at least two building modules:
where
each the at least two building modules is of identical size;
and
each of the at least two building modules is in the shape of a truncated tetrahedron;
where, to assemble a building:
one or more of a first form of building module is assembled with a hexagonal face against the horizontal surface;
one or more of a second form of building module is assembled with a triangular face against the horizontal surface,
and
a hexagonal surface of a at least one of the first form of building module is assembled exactly to abut with a hexagonal surface of at least one of a second form of building module to provide a horizontally tessellated structure.

2. The system of claim 1 comprising at least six building modules assembled into a tessellation, where triangular one or more depressions are left in the surface of the tessellation, the system further comprising one or more triangular sections fitted into the one or more depressions to provide a continuous level surface.

3. The system of any previous Claim, wherein;
the building comprises a plurality of storeys;
the tessellation of each lower storey provides an upper horizontal surface for construction of the next uppermost storey.

4. The system of claim 3 wherein,
if a lower storey presents one or more hexagonal uppermost faces of one or more building modules, the one or more hexagonal uppermost faces abut hexagonal lowermost faces of one or more building modules in an upper storey, and
if a lower storey presents one or more triangular uppermost faces of one or more building modules, the one or more triangular uppermost faces abut triangular lowermost faces in an upper storey.

5. The system of claim 4 wherein abutment of respective uppermost and lowermost hexagonal faces and alignment of respective uppermost and lowermost triangular faces provides one or more through passages are provided for provision of services and utilities.

6. The system of claim 5 wherein the services and utilities comprise at least one of: water supply pipes; sewerage pipes; gas pipes; electrical cables; ventilation ducts and pathways; data cables and roof drainage.

7. The system of any of the previous claims wherein each building module is provided as inhabitable space of sufficient size to accommodate human beings and their accoutrements.

8. The system of any of the previous claim wherein at least one building module comprises a plurality of constituent panels provided as a plurality of parts for the building module to be assembled on site.

9. The system, according to any previous claim, wherein at least one building module is provided completely or party pre-assembled.

10. The system, according to claim 9 or 10, wherein each panel comprises at least one of: at least one rigid planar sheet; and where there are provided two or more spaced rigid planar sheets, held there between, at least one of; a damp proof layer; a water proof layer; and a sound proof layer.

11. The system, according to claim 9, wherein at least one panel comprises: edge sealing components;
where
the edge sealing components include panel sealing adapted to seal for the edges of the plurality of spaced rigid planar sheets to isolated the interior from the environment;
and
environmentally sealed and angularly adapted edges for connection between panels.

12. A single building module in the form of a truncated tetrahedron, supported by a horizontal surface on a hexagonal face, the building module being of suitable size to accommodate a plurality of human beings, the building module being characterized by comprising:
a closable door;
and
one or more openable and closable window flaps to provide or exclude light from the interior.

13. The building module of claim 12 comprising:
a plurality of panels;
wherein
each panel comprises at least one of: at least one rigid planar sheet; and where there are provided two or more spaced rigid planar sheets, held there between, at least one of; a damp proof layer; a water proof layer; and a sound proof layer.

14. The building module of claim 13 wherein at least one panel comprises:
edge sealing components;
where
the edge sealing components include panel sealing adapted to seal for the edges of the plurality of spaced rigid planar sheets to isolated the interior from the environment;
and
environmentally sealed and angularly adapted edges for connection between panels.

15. The building module of any of claims 12 to 14 comprising, fitted around a plurality of interior sides thereof, at least one of: at least one continuous horizontal desk fitment; and at least one continuous horizontal shelf fitment.

16. A single building module in the form of a truncated tetrahedron, supported by a horizontal surface on a triangular face, the building module being of suitable size to accommodate a plurality of human beings, the building module being characterized by comprising:
a continuous horizontal bench, fitted around the interior of a plurality of sides thereof.

17. The building module of claim 16, comprising:
a sectional door;
where
at least a portion of the continuous horizontal bench is provided on at least a portion of the sectional door to be positioned as extended seating on the exterior of the building module when the sectional door is opened.

18. The building module of claim 16 or 17 wherein,
the sectional door is in the form of a hexagon covering an hexagonal surface of the building module;
the sectional door comprises six triangular panels each hinged along the hexagon edge;
and
the triangular panels are moveable from a closed position where all of the triangular panels meet at the hexagon centre to an open position.

19. The building module of claim 18 comprising a winch mechanism operable to open and close the triangular panels in common.
